(19) United States
(12) Patent Application Publication
(10) Pub. No.: US 2012/0309462 A1
(43) Pub. Date: Dec. 6, 2012

(54) Screen Expansion Dock for Smart Phone

(76) Inventor: Nikola Micev, Santa Barbara, CA (US)

(21) Appl. No.: 13/151,121

(22) Filed: Jun. 1, 2011

(51) Int. Cl. G06F 3/041; H04W 88/02

(52) U.S. Cl. 455/566; 345/173

(57) ABSTRACT

An expansion dock may include a first display screen to display video content and a video interface coupled to the first display screen, the video interface to receive the video content from a portable host computing device. The expansion dock may also include a multi-touch input surface (MTIS) overlaying the first display screen and a data interface to send touch data from the MITS to the portable host computing device. A mechanical coupling may position the portable host computing device in a known fixed position with respect to the first display screen.

### NOTICE OF COPYRIGHTS AND TRADE DRESS

A portion of the disclosure of this patent document contains material which is subject to copyright protection. This patent document may show and/or describe matter which is or may become trade dress of the owner. The copyright and trade dress owner has no objection to the facsimile reproduction by anyone of the patent disclosure as it appears in the Patent and Trademark Office patent files or records, but otherwise reserves all copyright and trade dress rights whatsoever.

### BACKGROUND

1. Field

This disclosure relates to personal computing devices.

2. Description of the Related Art

Portable personal computing devices have proliferated in recent years. It is not uncommon for a person to own a laptop computer, a tablet computer, a smart phone and/or a portable media player. Owning multiple personal computing devices entails unnecessary cost, since each device includes processing and communications capability and memory that is largely redundant between devices. Further, unnecessary time and effort may be required to transfer content between devices and to ensure that information such as telephone and e-mail directories and music playlists are synchronized between devices.

A “dock” is an apparatus that couples a portable computing device to external devices such as a larger display screen, a full-sized keyboard, and/or a conventional mouse. For example, docks for laptop computers typically connect the laptop to a large non-portable display, a keyboard, a mouse or other pointing device, and other peripherals. A dock thus effectively converts a laptop computer into a desk top computer. Recently, similar docks have become available to effectively convert a smart phone into a laptop or desktop computer.

### DESCRIPTION OF THE DRAWINGS

FIG. 1 is a block diagram of an expansion dock.

FIG. 2 is a front view of an exemplary expansion dock.

FIG. 3A is a rear view of the expansion dock of FIG. 2.

FIG. 3B is a side view of the expansion dock of FIG. 2.

FIG. 4A is a rear view of the expansion dock of FIG. 2 with a cover open.

FIG. 4B is a side view of the expansion dock of FIG. 2 with the cover open.

FIG. 5 is a front perspective view of another expansion dock.

FIG. 6 is a front perspective view of another expansion dock indirectly coupled to a host.

FIG. 7 is a rear perspective view of the of the expansion dock of FIG. 2 mounted on an accessory stand.

Throughout this description, elements appearing in figures are assigned three-digit reference designators, where the most significant digit is the figure number where the element is introduced. An element that is not described in conjunction with a figure may be presumed to have the same characteristics and function as a previously-described element having the same reference designator.

### DETAILED DESCRIPTION

Description of Apparatus

An “expansion dock” is an apparatus to provide an enhanced experience for the user of a smart phone or other portable computing device, including an expanded display screen and multi-touch input surface (MTIS). An expansion dock may also provide other enhancements, such as stereo speakers instead of earpieces. The enhanced user experience may be provided while retaining all of the capabilities of the smart phone host. Additionally, an expansion dock inherently ensures synchronization between the smart phone and a second computing device (such as a tablet compute) since one embodiment of an expansion dock may effectively convert the smart phone into a tablet computer. A tablet computer or other computing device implemented with a smart phone and an expansion dock can utilise the communications capability of the smart phone and thus does not require a separate data plan with a wireless communications carrier.

In this patent, a “portable host computing device” is defined as a mobile computing device that is capable of connecting to a mobile telephone service provider or other network, and includes a processor and memory capable of running an operating system and application programs, a display video output, a data input/output port, and one or more sensors capable of determining an orientation of the host device in two-dimensional or three dimensional space. The operating system may be a “mobile” operating system such as Apple IOS, Google Android, Microsoft Mobile Windows, HP WebOS, or other operating system. The sensors may include, for example, one or more of an accelerometer, a digital compass, a gyroscope, a GPS receiver, and/or other sensors.

In this application, the term “tablet computer” means a portable computer in which a touch screen having dimensions between two and 20 inches, rather than a keyboard and mouse, is the primary input device. Tablet computers are typically thin and flat with the display/touchscreen covering a large portion of one of the flat sides. Presently available tablet computers have display screens from 7.0 to 12.0 inches diagonal. The overall size of presently available tablet computers ranges from about 5″×7″×0.5″ to about 7″×10″×0.8″.

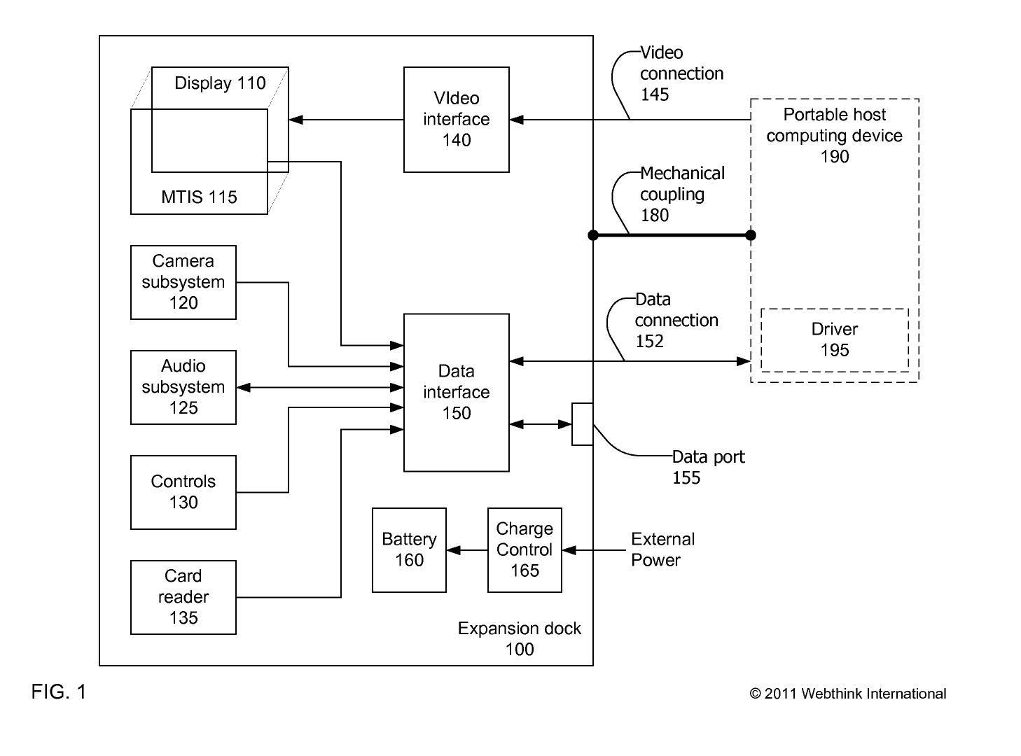

Referring now to FIG. 1, an exemplary expansion dock 100 may include a display screen 110 overlaid with a multi-touch input surface (MTIS) 115. The expansion dock 100 may include a video interface 140 connected to a portable host computing device 190 via a video connection 145. The portable host computing device 190 may be, for example, a smart phone. The expansion dock 100 may include a data interface 150 connected to the portable host computing device 190 via a data connection 152.

The display screen 110 may be similar in appearance and function to the display screens within conventional tablet computers. The display screen 110 may be rectangular in shape, having a longer dimension and a shorter dimension. The display screen resolution may be, for example, 800 to 1280 elements or higher along the long dimension, and 480 to 800 elements or higher along the short dimension. The display screen may be, for example, a liquid crystal display using fluorescent or LED (light emitting diode) back lighting, an LED display, or other flat panel display.

The MTIS 115 may overlay the entire surface of the display screen 110. The MTIS 115 may allow a user to manipulate screen content by touching, tapping, pinching, and wiping the exterior surface overlaying the display screen. The MTIS 115 may include, for example, a capacitive touch screen and a multi-touch processor.

The expansion dock 100 may include a camera subsystem 120. The camera subsystem may include at least one camera (not shown) and processing circuitry configured to convert an image or video stream from the camera into a format suitable for transmission to the portable host computing device 190. In this patent, the term “processing circuitry” includes analog circuits, digital circuits, processors, memory, and other circuits configured to perform a disclosed function. The camera subsystem 120 may include a first camera facing in a direction normal to the surface of the display 110 such that a user of the expansion dock may be within the field of view of the first camera. For example, the first camera may be used for video telephone calls and video chats via the Internet. The camera subsystem 120 may include a second camera facing in the opposite direction.

The expansion dock 100 may include an audio subsystem 125. The audio subsystem 125 may include a microphone (not shown) and speakers (not shown) which may be used, for example, in conjunction with the first camera for video telephone calls and video chats. The speakers may also be used to reproduce music or the audio portion of movies and other video content shown on the display 110. The audio subsystem may include a connector for external speakers and/or an external microphone in addition to, or as an alternate for, internal speakers and microphone. The audio system 125 may include processing circuitry configured to convert analog audio signals from the microphone into digital form for transmission to the portable host computing device 190 and/or to convert digital information from the portable host computing device 190 into analog audio signals to drive the speakers.

The expansion dock 100 may include controls 130. The controls 130 may include, for example, a power on/off button, a sleep/wake button, volume up/down buttons, and other controls that may be mapped to perform various tasks supported by the software running on the portable host computing device 190.

The expansion dock 100 may contain a card reader 135 configured to accept one or more memory card formats. The memory card formats accepted by the card reader 135 may include, for example, Secure Digital (SD) cards, SDHC (high capacity) cards, mini SD cards, micro SD cards, Multimedia cards (MMC), memory sticks, and compact flash cards. The expansion dock 100 may be configured to both read and write content from a card installed in the card reader 135.

The video interface 140 may receive video information from the portable host computing device 190 via the video connection 145. The video connection 145 may be wired or wireless. The video connection 145 may be compatible with one or more digital video interface standards such as HDMI (High Definition Media Interface), DVI (digital video interface), Display Link, MHL (mobile high-definition link), DisplayPort, Mini DisplayPort, or Thunderbolt. The video interface 140 may containing processing circuit to convert the digital video information from the video connection 145 into the format required to drive the display panel 110.

The data interface 150 may communicate with the portable host computing device 190 via a data connection 152. The data connection 152 may be wired or wireless. The data connection 152 may be, for example, USB. The expansion dock may have one or more additional data ports 155 to connect peripheral devices such as a keyboard or printer. The data interface 150 may include processing circuitry configured to transfer data from the MTIS 115, the camera subsystem 120, the audio subsystem (i.e. microphone) 125, the controls 130 and the card reader 135 to the portable host computing device 190 via the data connection 152. Similarly, the data interface 150 may include processing circuitry configured to transfer data received from the portable host computing device 190 via the data connection 152 to the audio subsystem (i.e. speakers) 125 and the card reader 135.

The expansion dock 100 may include a battery 160 and a battery charge controller 165 to control charging the battery from an external power source. The battery 160 may provide power to the portable host computing device 190 via the data port 155. The capacity of the battery 160 may be substantially greater than a capacity of a battery within the portable host computing device 190, such that the host battery may be charged from the battery 160.

The software running on the portable host computing device 190 may include a driver 195 for the expansion dock 100. When the portable host computing device is coupled to an expansion dock, the driver 195 may disable a display screen of the portable host computing device 190 and route video content generated by the portable host computing device 190 to the display screen 110 via the video connection 145. The driver 195 may also disable an MTIS within the portable host computing device 190 and instead provide information from the MTIS 115 of the expansion dock 100 to the portable host computing device 190 via the data connection 155. Similarly, when the expansion dock includes the camera subsystem 120, the driver 195 may also disable one or more cameras within the portable host computing device 190 (e.g., cameras which are obstructed by the expansion dock 100) and instead use the camera system 120 of the expansion dock 100, for example when engaging in video telephone calls or video chats.

Other than the previously described processing circuitry, the expansion dock 100 may exclude a general purpose processor, memory, and storage. The expansion dock 100 may be incapable of executing an operating system or application programs. Instead, the expansion dock 100 may rely on the processor, operating system, and applications programs of the portable host computing device 190 for all user-facing computational tasks. The expansion dock 100 also may exclude any communications capability other than the previously described display port and one or more data ports. The expansion dock 100 may rely on the communications resources (cellular, Wi-FI, Bluetooth, etc.) of the portable host computing device 190 for communications with networks and devices external to the expansion dock.

The portable host computing device 190 may be mechanically coupled to the expansion dock 100, as indicated schematically by the mechanical coupling 180. The term “mechanically coupled” means that the portable host computing device 190 is positioned in a known and fixed position with respect to the display screen 110 of the expansion dock 100. For example, the portable host computing device 190 may be physically attached to the expansion dock 100 in a known location. The portable host computing device 190 and the expansion dock 100 may be mechanically coupled without physical attachment if the relative positions of the portable host computing device 190 and the expansion dock 100 are known and fixed.

If the portable host computing device 190 is disposed in a known and fixed position with respect to the display screen 110 of the expansion dock 100, position and orientation sensors within the portable host computing device 190 can be used to format the content presented on the display screen 110. For example, an orientation sensor within the portable host computing device 190 may be used to determine if the content on the display screen 110 should be landscape or portrait format. Further, a position sensor or direction sensor within the portable host computing device 190 may be used to properly orient position-sensitive and/or direction sensitive content, such as maps, on the display screen 110. For further example, a GPS receiver and a direction sensor within the portable host computing device may determine a location and orientation of the display screen 110. In this case, the video content displayed on the display screen 110 can be tailored to a user's location and orientation, allowing the host/expansion dock to function as a portable guidebook for a museum or shopping mall.

The depiction in FIG. 1 of the expansion dock 100 as a set of functional elements does not imply any corresponding physical separation or demarcation. The functional elements of the expansion dock 100 may be implemented in hardware including digital circuits, analog circuits, and processors. The functional elements of the expansion dock 100 may be implemented, at least in part, by software and/or firmware executing on one or more processors. All or portions of one or more functional elements may be collocated within a common programmable circuit device or application specific integrated circuit. Any of the functional elements may be divided between two or more circuit devices. An expansion dock may include additional functional elements not shown in FIG. 1.

The expansion dock 100 may also be operated with a host other than a portable host computing device. For example, the expansion dock may be coupled to a laptop or desktop personal computer to provide an auxiliary display screen, camera, and MTIS input device.

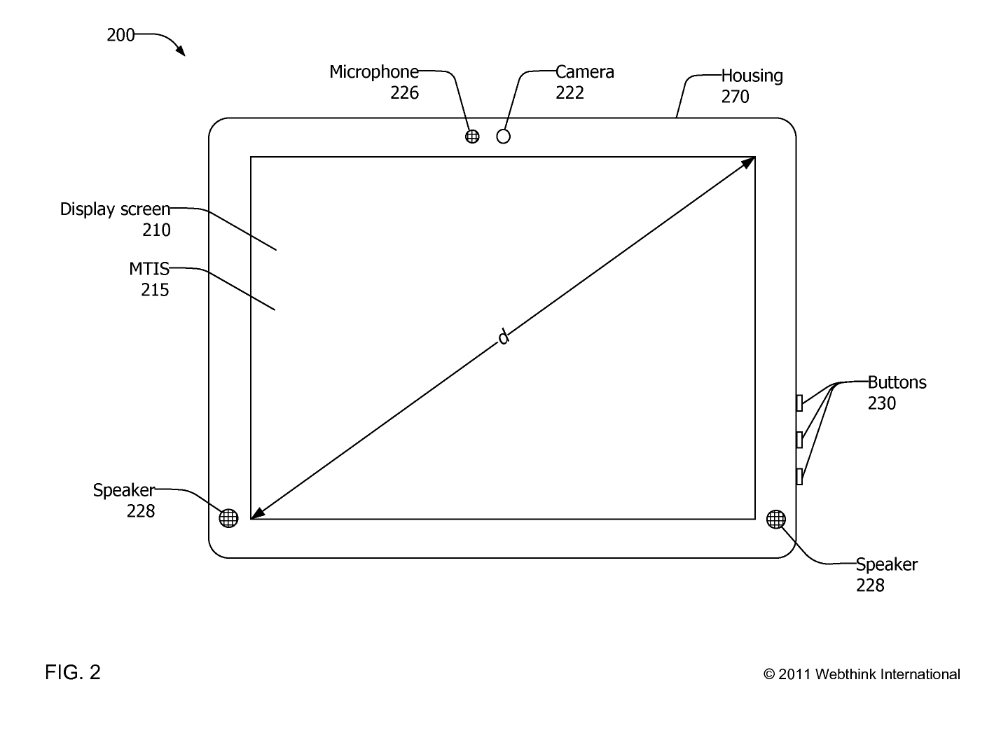

FIG. 2 through FIG. 5 show an exemplary expansion dock for emulating a tablet computer using a portable host computing device, which may be a smart phone. As shown in the front view of FIG. 2, a large portion of the front surface of the expansion dock 200 may be occupied by the display screen 210 and overlaid MTIS 215. A diagonal size d of the display screen may be, for example, from about seven to about thirteen inches. A camera 222, a microphone 226, and two speakers 228 may be located outside the perimeter of the display screen 210. Controls, such as buttons 230, may also be place about the perimeter of the expansion dock or in other locations. The location of the camera, microphone, speakers, and controls in FIG. 2 is exemplary. These components may be located elsewhere on the expansion dock 200.

A housing 270 may enclose the components of the expansion dock 200. A thickness of the housing 270, normal to the surface of the display screen 210, may be small compared to the dimension d. The thickness of the housing may be, for example, less than one inch.

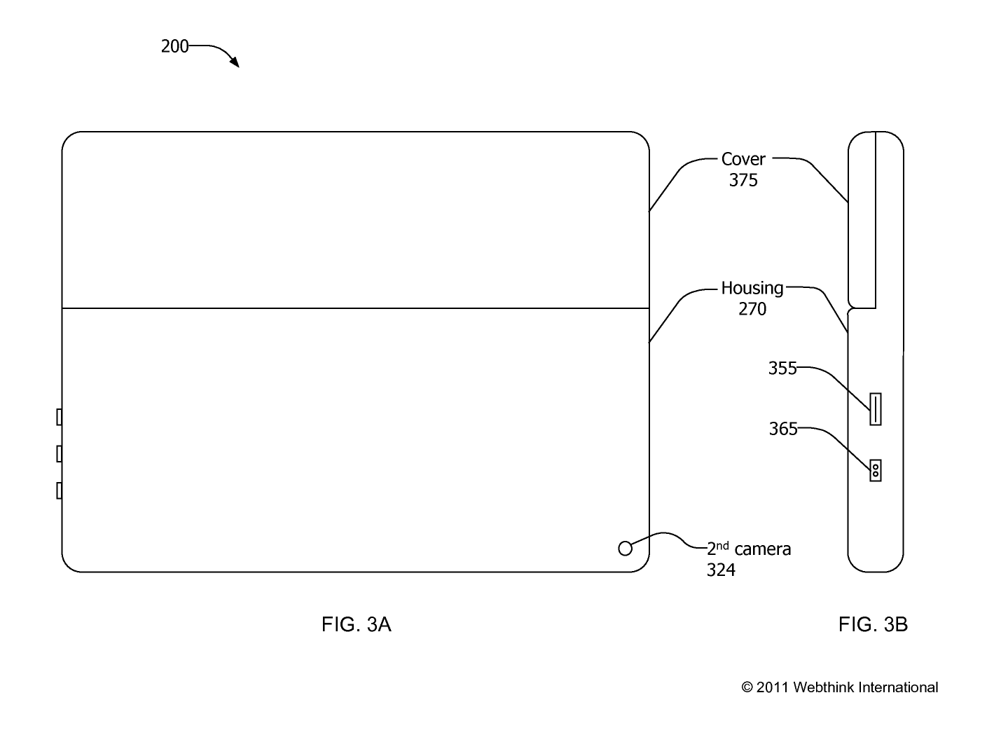

FIG. 3A and FIG. 3B are rear and side views, respectively, of the expansion dock 200. A second camera 324 may view an outside scene through an aperture in the housing 270. Connectors, which may include a power connector 365 and/or one or more USB connectors 355, may be located on the side, back, or elsewhere on the housing 270. A cover 375 may be openable to expose a portion of the volume within the housing.

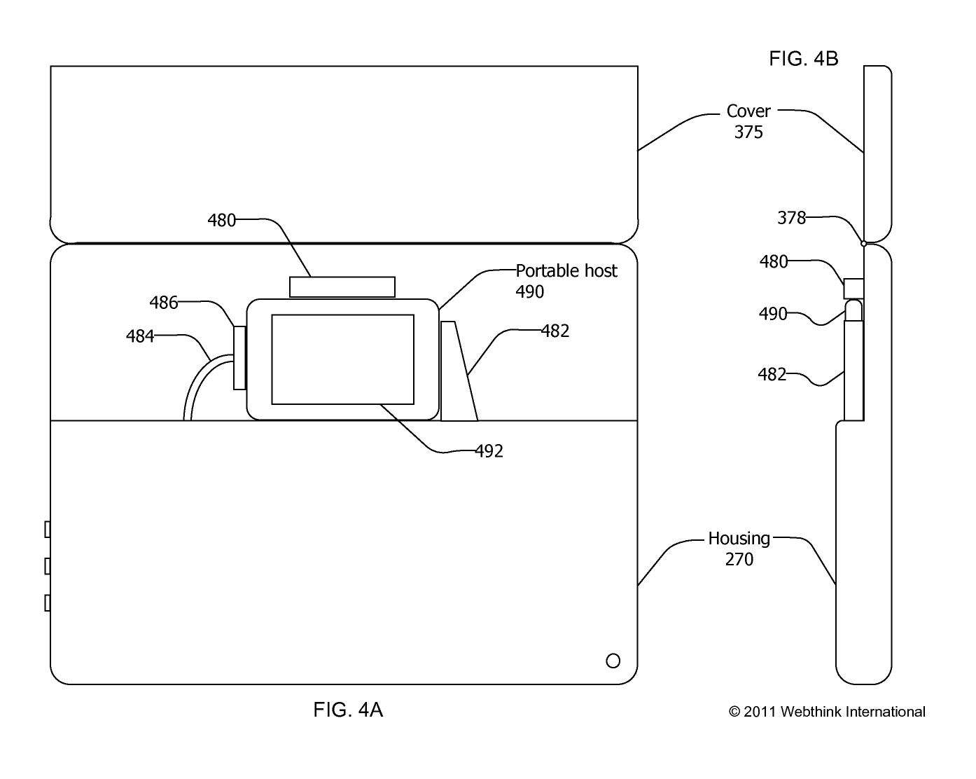

FIG. 4A and FIG. 4B are rear and side views, respectively, of the expansion dock 200 with the cover 375 in an open position. As shown in FIGS. 4A and 4B, the cover 375 may, for example, rotate about a hinge 378 to the open position. The cover 375 may slide to an open position. The cover 375 may be removable. The cover 375 may open in some other manner. Although not shown in FIGS. 4A and 4B, the cover may be retained in its closed position using a catch, a latch, a magnetic retainer, or some other mechanism.

Moving the cover 375 to its open position may expose a space configured to hold a portable host computing device 490. Opening the cover 375 may expose one or more retaining elements to retain the portable host computing device 490 in a known and fixed position within the expansion dock 200 and one or more connection elements to electrically connect the portable host computing device 490 to the expansion dock 200. The portable host computing device 490 may be connected to the expansion dock 200 as the host (190 in FIG. 1).

In the example of FIGS. 4A and 4B, the retaining elements may include one more blocks 480 to hold the portable host computing device 490 in a known and fixed position within the expansion dock 200. The block 480 may be configurable or positionable to accommodate portable host computing devices of various sizes and shapes. The block 480 may be resilient and may supply a compressive force against the portable host computing device 490 to retain the portable host computing device in the known and fixed position relative to the expansion dock 200. The retaining elements may include other structures or devices in addition to, or instead of, the block 480. The retaining elements may include one or more springs, clamps, clips, straps, pillows, and other devices adapted to temporarily affix the portable host computing device 490 to the expansion dock 200 in the known and fixed position.

The portable host computing device 490 may be mechanically coupled to the expansion dock 200 such that a plane of a display screen 492 of the portable host computing device 490 may be parallel to a plane of the display screen 210 of the expansion dock 200, and a long dimension of the display screen 492 of the portable host computing device 490 may be parallel to a long dimension of the display screen 210 of the expansion dock 200. In this case, one or more sensors within the portable host computing device 490 may be used to orient content for display on the display screen 210 exactly as the content would be shown on the display screen of the portable host computing device. A portable host computing device may be disposed in some other known and fixed orientation with respect to as expansion dock (i.e., an orientation where the surface and edges of the portable host computing device display screen are not parallel to the surface and edges of the expansion dock display screen). In this case, software running on the portable host computing device may compensate for the relative position/orientation of the portable host computing device and expansion dock display screens.

The connecting elements may include one or more connectors for the video connection and the data connection between the cell phone 490 and the expansion dock 200. Connectors may be disposed within a structure 482 adjacent to the predetermined position of the portable host computing device 490 such that the connections between the portable host computing device 490 and the expansion dock 200 occur automatically when the portable host computing device is placed its known and fixed position. Alternatively, connections between the expansion dock 200 and the portable host computing device 490 may be made via a short umbilical cable 484 ending in one or more connectors 486. The connecting elements of the expansion dock 200 may include both fixed connectors for certain types or models of portable host computing devices and an umbilical cable for other types of portable host computing devices. The connections between the portable host computing device 490 and the expansion dock 200 may be wireless.

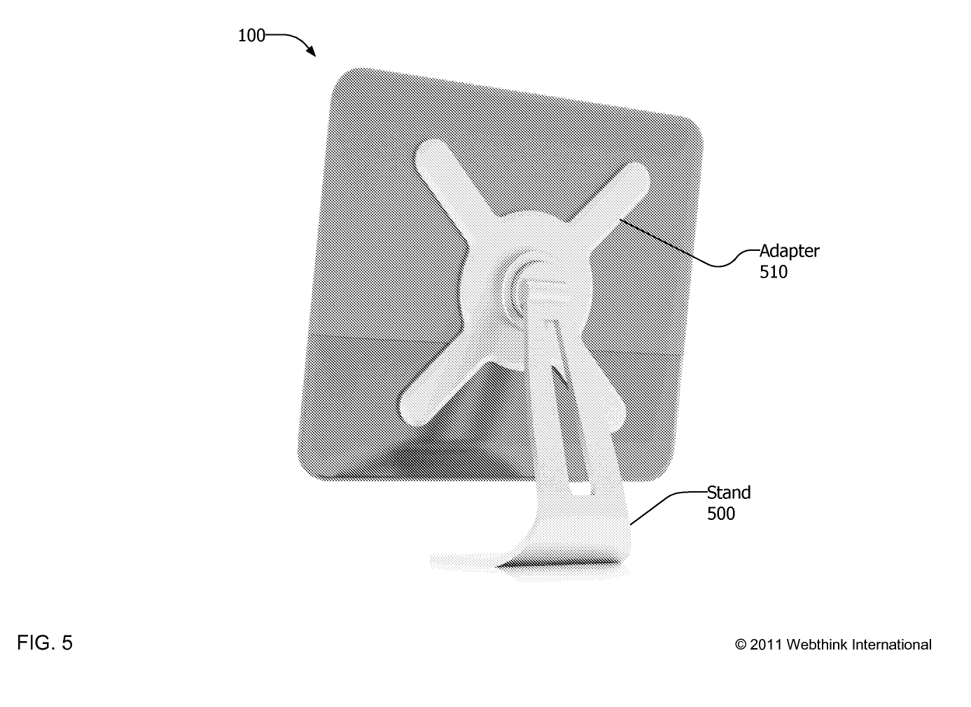

As shown in FIG. 5, the expansion dock 200 may be coupled to an adapter 510 which, in turn may be connectable to any VESA (Video Electronics Standards Association) mount, such as the stand 500. Mounting the expansion dock 200 on a stand may be particularly useful when the expansion dock is used as an auxiliary display for a desktop computer.

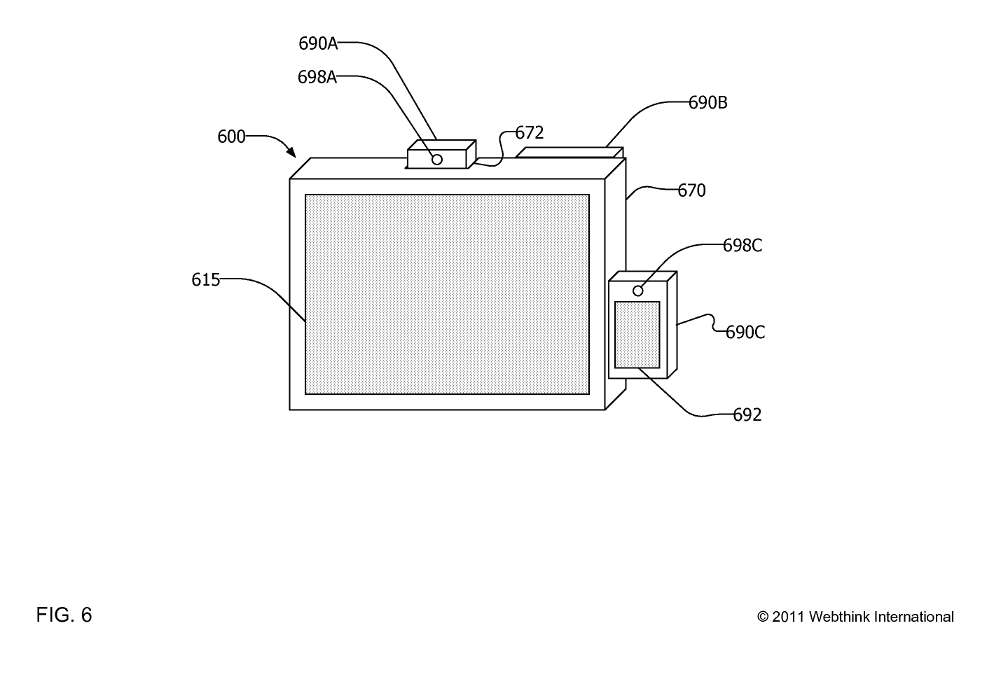

In the example of FIG. 2-FIG. 5, the portable host computing device host 490 was disposed in the interior of the expansion dock 200 accessible through an openable cover 375. A smart phone or other host may be mechanically coupled to an expansion dock differently, as illustrated in FIG. 6. FIG. 6 shows portable host computing devices 690A, 690B, and 690C mechanically coupled to an expansion dock 600 in three different positions. It should be understood that these three positions are presented as examples, and an expansion dock may be configured to only accept a portable host computing device in a single position.

The portable host computing device 690A may be partially enclosed in a cavity or recess 672 in the expansion dock. The cavity or recess 672 may locate the portable host computing device 690A in a known fixed position relative the expansion dock. The portable host computing device 690A may be held in position, for example, by spring catches, detents, a strap, or some other element. The portable host computing device 690A may be positioned such that a camera 698A is exposed, obviating the need for the expansion dock 600 to include a user-facing camera.

The portable host computing device 690B may simply be attached to a back surface of the expansion dock 600 and held in place, for example, by one or more straps. The portable host computing device 690C may be attached to an edge of the expansion dock 600 and held in position by the action of connectors for a video connection and a data connection between the portable host computing device 690C and the expansion dock 600. Mounting the portable host computing device 690C to an edge of the expansion dock 600 allows both a display screen 615 of the expansion dock 600 and a display screen 692 of the portable host computing device to be visible. The positions of the portable host computing device 690B and the portable host computing device 690C may make the portable host computing device vulnerable to physical damage and inadvertent disconnection from the expansion dock 600.

Each of the portable host computing devices 690A, 690B, 690C may be mechanically attached to the expansion dock 600 such that there is a known fixed geometric relationship between the display screen 615 and a display screen of each portable host computing device. For example, the surface of a display screen 692 of portable host computing device 690C may be parallel to the surface of the display screen 615, and a long edge of the display screen 692 may be parallel to a short edge of the display screen 615. In this example, an orientation sensor within the portable host computing device 690C may be used to determine the orientation of content displayed on the display screen 615. However, an output of the orientation sensor must be logically inverted such that content is displayed in landscape format on the display screen 615 in circumstances when content would have been displayed in portrait format on the display screen 692.

An expansion dock may take a variety of forms in addition to a tablet computer as shown in FIG. 2-FIG. 5. For example, a large-screen expansion dock may be mounted on a wall for viewing motion pictures and other video content. An expansion dock for use as a desk-top computer may be mounted on a stand and coupled to a keyboard, mouse, and other peripherals. An expansion dock may be integrated into an item of furniture such as a game table, or into a chart table on a boat or ship.

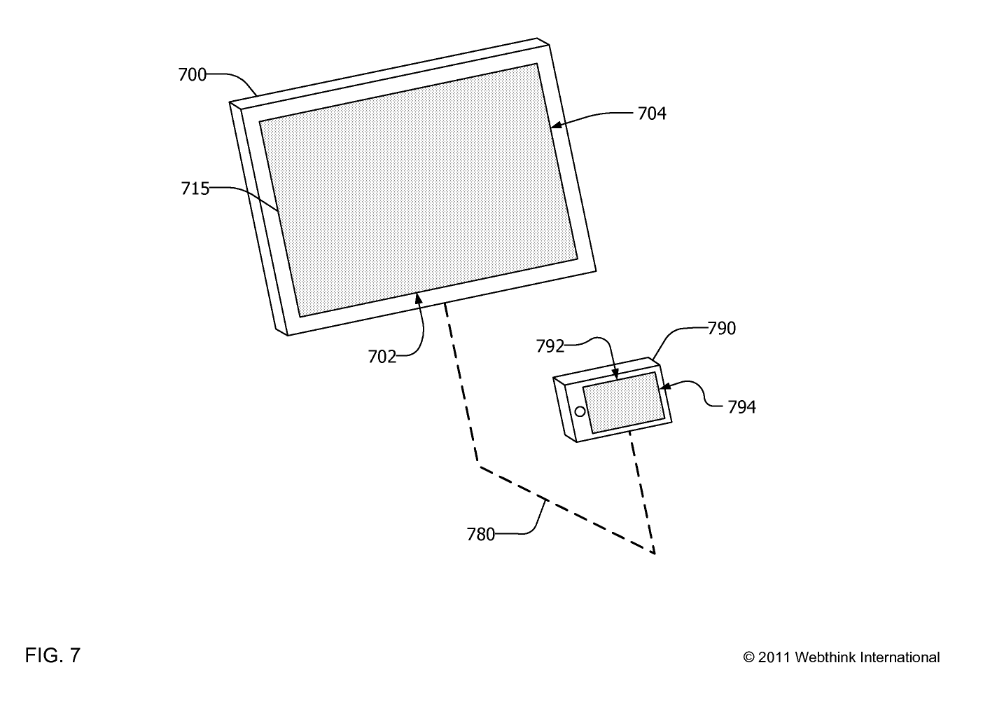

Referring now to FIG. 7 a portable host computing device 790 may be mechanically connected to an expansion dock 700 by an indirect mechanical coupling, which is to say connected without a direct physical contact between the portable host computing device and the expansion dock. For example, the expansion dock 700 may be permanently mounted in the instrument panel of an automobile or other vehicle (not shown). The portable host computing device 790 may be detachably mounted in a fixture (not shown) in the center console between the front seats of the vehicle. In this case, the indirect mechanical coupling between the portable host computing device 790 and the expansion dock 700 is the structure of the vehicle, as indicated schematically by the dashed line 780.

The fixture may be configured to position the portable host computing device 790 with a known fixed geometric relationship between the portable host computing device and the expansion dock 700. For example, a long edge 792 of a display of the portable host computing device 790 may be parallel to a long edge 702 of the display 715 of the expansion dock 700. A short edge 794 of the display of the portable host computing device 790 may be parallel to a short edge 704 of the display 715 of the expansion dock 700. In this case, a surface of the display of the portable host computing device may be parallel to a surface of the display 715.

A video connection and a data connection between the portable host computing device 790 and the expansion dock 700 may be provided wirelessly or through cables (not shown) provided within the vehicle.

Closing Comments

Throughout this description, the embodiments and examples shown should be considered as exemplars, rather than limitations on the apparatus and procedures disclosed or claimed. Although many of the examples presented herein involve specific combinations of method acts or system elements, it should be understood that those acts and those elements may be combined in other ways to accomplish the same objectives. With regard to flowcharts, additional and fewer steps may be taken, and the steps as shown may be combined or further refined to achieve the methods described herein. Acts, elements and features discussed only in connection with one embodiment are not intended to be excluded from a similar role in other embodiments.

As used herein, “plurality” means two or more. As used herein, a “set” of items may include one or more of such items. As used herein, whether in the written description or the claims, the terms “comprising”, “including”, “carrying”, “having”, “containing”, “involving”, and the like are to be understood to be open-ended, i.e., to mean including but not limited to. Only the transitional phrases “consisting of” and “consisting essentially of”, respectively, are closed or semi-closed transitional phrases with respect to claims. Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements. As used herein, “and/or” means that the listed items are alternatives, but the alternatives also include any combination of the listed items.

1. An expansion dock, comprising:
a first display screen to display video content
a video interface coupled to the first display screen, the video interface to receive the video content from a portable host computing device
a multi-touch input surface (MTIS) overlaying the first display screen
a data interface to send touch data from the MITS to the portable host computing device
a mechanical coupling to position the portable host computing device in a known fixed position with respect to the first display screen.

2. The expansion dock of claim 1, wherein the mechanical coupling is a physical connection between the portable host computing device and the expansion dock.

3. The expansion dock of claim 2, further comprising:
at least one retaining element to retain the portable host computing device in the known fixed position.

4. The expansion dock of claim 1 wherein
the portable host computing device includes a second display screen, and
the portable host computing device is positioned with an edge of the second display screen parallel to an edge of the first display screen.

5. The expansion dock of claim 1 wherein
the portable host computing device includes a second display screen, and
the portable host computing device is positioned with a surface of the second display screen parallel to a surface of the first display screen.

6. The expansion dock of claim 1 wherein
the portable host computing device includes a second display screen having a first edge and as second edge orthogonal to the first edge,
the first display screen has a long edge and a short edge, and
the portable host computing device is positioned with the first edge of the second display screen parallel to the long edge of the first display screen and the second edge of the second display screen parallel to the short edge of the first display screen.

7. The expansion dock of claim 1, wherein the mechanical coupling is an indirect coupling.

8. The expansion dock of claim 7, wherein
the expansion dock is a portion of a vehicle, and
the indirect coupling is provided by the structure of the vehicle.

9. The expansion dock of claim 1 wherein
the portable host computing device is a smart phone.
